(19) United States
(12) Patent Application Publication
(10) Pub. No.: US 2002/0055369 A1
(43) Pub. Date: May 9, 2002

(54) Discrete type portable visual terminal system

(75) Inventors: Yoshitaka Nakamura, Tokyo (JP); Naoki Hikishima, Tokyo (JP)

Correspondence Address: SUGHRUE, MION, ZINN, MACPEAK & SEAS, PLLC, 2100 Pennsylvania Avenue, N.W., Washington, DC, 20037-3213, US

(73) Assignee: NEC CORPORATION

(21) Appl. No.: 09/984,516

(22) Filed: Oct. 30, 2001

(30) Foreign Application Priority Data
Nov. 7, 2000 (JP) 338818/2000

(51) Int. Cl. H04M 1/00

(52) U.S. Cl. 455/556; 455/566

(57) ABSTRACT

There is provided a discrete type portable visual terminal system, in which a mobile device and a portable visual terminal are connectable/separable, and easier data administration of an address file is achieved. The discrete type portable visual terminal system comprises a mobile device and a portable visual terminal, each including a controller (CPU), a nonvolatile memory (ROM) for storing address data, a keyboard for inputting data, and an external interface driver. On the occasion when the mobile device and the portable visual terminal are connected, address data are automatically transferred/downloaded from one address file to the other address file, thus enabling the mobile device and the portable visual terminal to share the address data.

### BACKGROUND OF THE INVENTION

The present invention relates to a portable visual terminal system, and in particular, to a discrete type portable visual terminal system comprising a mobile device and a portable visual terminal, which are connectable/separable.

### DESCRIPTION OF THE RELATED ART

There is an increasing need to transmit characters, a static image and a dynamic image as well as voice in association with the development of communication means. One such example is a videophone system. As the videophone system and prior art thereof, for example, Japanese Patent Application Laid-Open No. 2000-50223 discloses “videophone system”. In addition, Japanese Patent Application Laid-Open No. 2000-92184, No. 2000-151851, No. 2000-224659 and No. 2000-253137 disclose “mobile telecommunication terminal unit”, “multimedia communication terminal unit and multimedia communication system”, “cellular phone, extension unit for videophone, and videophone system” and “pictorial communication terminal, pictorial communication system and mobile station”, respectively.

Besides, there has been proposed a discrete type portable videophone system, in which a mobile device (radio section) and a portable visual terminal (image display section) are separated from each other. In the conventional portable videophone system, each of the mobile device side and portable visual terminal side is provided with an address file. A user often carries the mobile device on him/her, while he/she generally carries the portable visual terminal in a bag or does not carry around the terminal. Under this situation, when the user obtains a videophone number that he/she wants to list in the address file, he/she she has to go to the trouble to take the portable visual terminal out of the bag to input the number, or, if he/she left the terminal home, he/she has to input the number after returning home. In addition, in order to enroll the number into the address files of both the mobile device and the portable visual terminal, the user needs to conduct the same operation twice.

### SUMMARY OF THE INVENTION

It is therefore an object of the present invention to provide a discrete type portable visual terminal system, which minimizes the trouble of inputting data to address files, in a smaller size.

In accordance with the present invention, there is provided a discrete type portable visual terminal system comprising a connectable/separable mobile device and a portable visual terminal, each of which includes a controller, a memory for storing address data, and an external interface driver, wherein the address data stored in the memory of the mobile device or the portable visual terminal are transferred/downloaded to the other memory via the external interface drivers, and thus the mobile device and the portable visual terminal have the address data in common.

In accordance with the present invention, only the mobile device includes an address data input means such as a keyboard or a software keyboard, and address data of the mobile device are transferred/downloaded to the portable visual terminal. Besides, the address data of the mobile device are transferred/downloaded when the mobile device and the portable visual terminal are connected, and/or the address data of the mobile device are automatically transferred/downloaded to the portable visual terminal on the occasion of updating the address file of the mobile device. Furthermore, the address data input means such as a keyboard or a software keyboard may be provided to each of the mobile device and the portable visual terminal, and each other's address data are mutually transferred to supplement each other's address file when the mobile device and the portable visual terminal are connected.

### BRIEF DESCRIPTION OF THE DRAWINGS

The objects and features of the present invention will become more apparent from the consideration of the following detailed description taken in conjunction with the accompanying drawings in which:

FIG. 1 is a block diagram showing the structure of a discrete type portable visual terminal system according to a preferred embodiment of the present invention;

FIG. 2 is a flow chart showing operations to alter the data in an address file of the mobile device illustrated in FIG. 1;

FIG. 3 is a flow chart showing data communization processes in the case that data are added to an address file on either mobile device side or portable visual terminal side, and the data are to be shared with the other side; and

FIG. 4 is a flow chart showing data communization processes in the case that data are added to the address files individually at the mobile device and the portable visual terminal.

### DESCRIPTION OF THE PREFERRED EMBODIMENT

Referring now to the drawings, a description of preferred embodiments of the present invention will be given in detail.

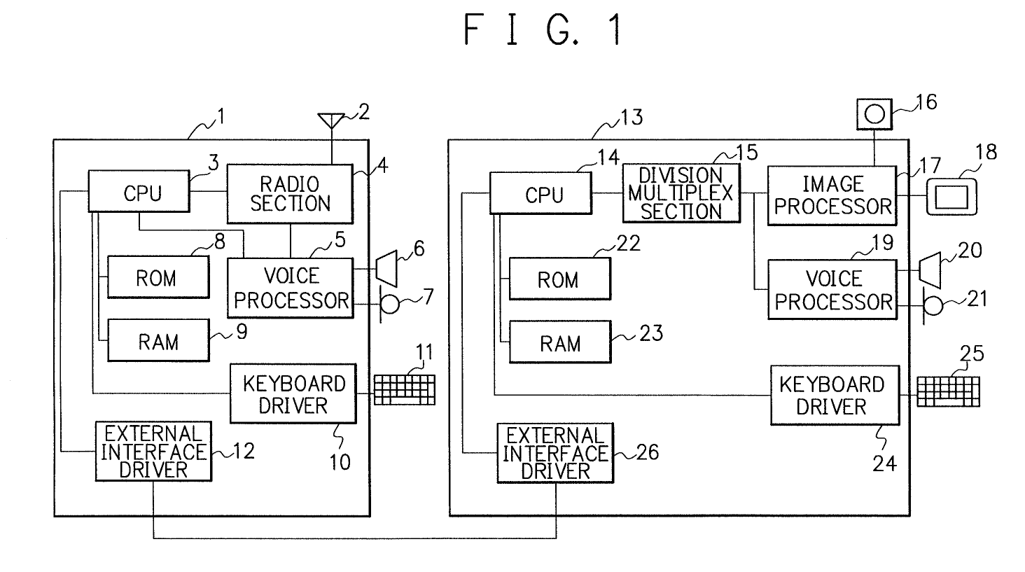

FIG. 1 is a configuration diagram showing a discrete type portable visual terminal system according to a preferred embodiment of the present invention. The discrete type portable visual terminal system comprises a mobile device 1 and a portable visual terminal 13, which can be used while being separated from, and also integrated with the mobile device 1. The mobile device 1 includes an antenna 2, a controller (CPU: Central Processing Unit) 3, a radio section 4, a voice processor 5, a speaker 6, a microphone 7, a read only memory (ROM) 8, a random access memory (RAM) 9, a keyboard driver 10, a keyboard 11, and an external interface driver 12. The antenna 2 is connected to the radio section 4. The CPU 3 is connected to the radio section 4, the voice processor 5, the ROM 8, the RAM 9, the keyboard driver 10, and the external interface driver 12. The voice processor 5 is also connected to the speaker 6 and the microphone 7, as well as the radio section 4. In addition, the keyboard 11 is connected to the keyboard driver 10.

On the other hand, the portable visual terminal 13 includes a controller (CPU) 14, a division multiplex section 15, an image processor 17, a voice processor 19, a ROM(s) 22, a RAM(s) 23, a keyboard driver 24, and an external interface driver 26. The CPU 14 is connected to the division multiplex section 15, the ROM 22, the RAM 23, the keyboard driver 24, and the external interface driver 26. The image processor 17 is connected to the division multiplex section 15, a camera 16 and an image element 18. The voice processor 19 is connected to the division multiplex section 15, a speaker 20 and a microphone 21. The keyboard driver 24 is connected to a keyboard 25. Besides, the external interface driver 26 of the portable visual terminal 13 is connected to the external interface driver 12 of the mobile device 1.

In the following, the function of each part will be explained. The CPU 3 of the mobile device 1 conducts the integrative control of the mobile device 1. The antenna 2 communicates with other mobile devices via a base station etc. by radio. The radio section 4 modulates/demodulates radio waves. The voice processor 5 compresses voice data inputted from the microphone 7, and uncompresses receive data from a net to output the data from the speaker 6 as voice. The ROM 8 is a nonvolatile memory for storing data that are not to be deleted. The RAM 9 is a memory for storing temporary data. The keyboard 11 is used for inputting data to the keyboard driver (processing section) 10. The data is processed at the keyboard driver 10, and accordingly the CPU performs the control operation. The external interface driver 12 transmits/receives data to/from the portable visual terminal 13 when connected with the terminal 13.

With regard to the portable visual terminal 13, the CPU 14 conducts the integrative control of the portable visual terminal 13. The image processor 17 compresses an image shot by the camera 16 to generate transmission data, and uncompresses receive data from a net to display the data on the image element 18 (graphic display device). The voice processor 19 compresses voice data inputted from the microphone 21, and uncompresses receive data from a net to output the data from the speaker 6 as sound. The division multiplex section 15 divides receive data from a net into voice and image, and multiplexes data from the image processor 17 and the voice processor 19. The ROM 22 is a nonvolatile memory for storing data that are not to be deleted. The RAM 23 is a memory for storing temporary data. The keyboard 25 is used for inputting data. The input from the keyboard 25 is then processed at the keyboard driver 24, and the CPU operates corresponding to the processed data. In addition, the external interface driver 26 transmits/receives data to/from the mobile device 1 when connected with the mobile device 1.

Incidentally, it is possible to log onto the Internet by using the portable visual terminal, and download a music software, a video software and a game software from the Internet.

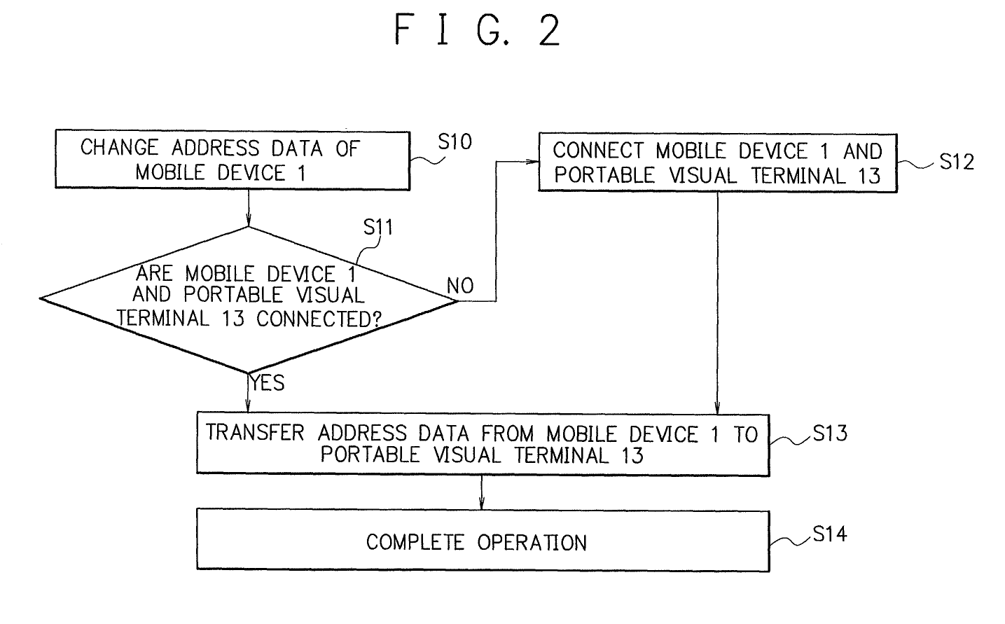

Next, operations shown in FIG. 1 will be explained with reference to the flow chart of FIG. 2. FIG. 2 illustrates processing operations in the case where address data of the mobile device 1 are changed when the mobile device 1 and the portable visual terminal 13 are logically connected to each other (irrespective of by wire or by air) via the external interface drivers 12 and 26, and mutually acknowledge one another's existence. Here, only the mobile device 1 is capable of changing address data and the portable visual terminal 13 reads the data, so that it is easier to communize the data.

When data are inputted to the address file by the keyboard 11 on the mobile device side (step S10), the CPU 3 stores the data in the ROM 8 through the keyboard driver 10. At this point, it is judged that whether or not the mobile device 1 and the portable visual terminal 13 are connected (step S11). In the case where the mobile device 1 and the portable visual terminal 13 are connected (step S11: YES), the portable visual terminal 13 downloads the address data from the mobile device 1 via the external interface drivers 12 and 26 (step S13). The CPU 14 of the portable visual terminal 13, which has downloaded the address data, stores the data in the ROM 22 as its own address data, and the operations are completed (step S14).

On the other hand, in the case where the mobile device 1 and the portable visual terminal 13 are not connected (step S1: NO), it is waited that the mobile device 1 and the portable visual terminal 13 are to be connected (step S12). When the connection is made, the address data are automatically transferred (step S13). Owing to the above structure and operations, the portable visual terminal 13 can share the latest address data with the mobile device 1 without having its own input device such as the keyboard 25.

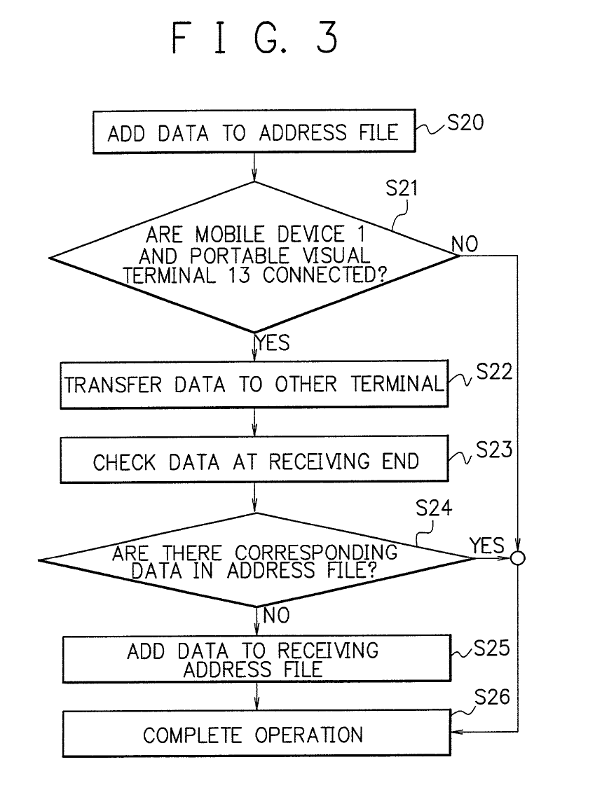

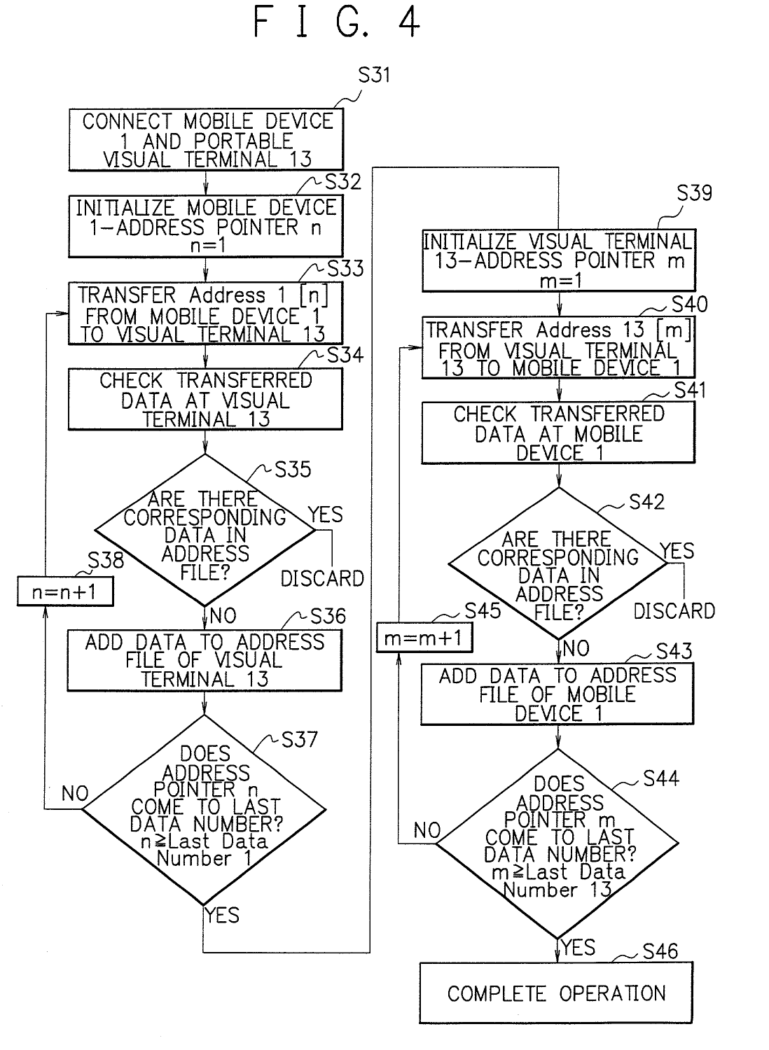

Next, a description will be given of a portable visual terminal according to another embodiment of the present invention. In the above embodiment of the present invention, only the mobile device 1 is provided with an address file that can be edited, and the portable visual terminal 13 downloads data from the address file to have the address data in common. However, the address data may be shared when both the mobile device 1 and the portable visual terminal 13 posses address files that can be edited. In such case, items of their address data are checked one by one, and their address files are mutually complemented. Operations in this case will be described with reference to the flow charts of FIGS. 3 and 4.

FIG. 3 is a flowchart showing processing operations in the case where address data are added to the address file of the mobile device 1 or the portable visual terminal 13 when the mobile device 1 and the portable visual terminal 13 are logically connected to each other (irrespective of by wire or by air) via the external interface drivers 12 and 26, and mutually acknowledge one another's existence. For example, when there is an input to the address file from the keyboard 11, namely, when data are added to the address file on the mobile device side (step S20), the CPU 3 stores the data in the ROM 8 through the keyboard driver 10. Subsequently, it is judged that whether or not the mobile device 1 and the portable visual terminal 13 are connected (step S21). In the case where the mobile device 1 and the portable visual terminal 13 are connected (step S21: YES), the mobile device 1 transfers the data to the portable visual terminal 13 at the other end via the external interface drivers 12 and 26 (step S22). The CPU 14 of the portable visual terminal 13, which has received the address data, collates each item of the data with data stored in the ROM 22 (step S23) to determine whether or not the item of the address data exists in the ROM 22 of the portable image terminal 13 at the receiving end (step S24). If the address data do not exist (step S24: NO), the data are additionally stored in the ROM 22 as address data (step S25). On the other hand, if the same address data exist (step S24: YES), or if the mobile device 1 and the portable visual terminal 13 are not connected at the step 21 (step S21: NO), the address data is discarded, and the operations are completed (step S26).

Contrary to the above case, when there is an input to the address file from the keyboard 25 on the portable visual terminal 13 side, the CPU 14 stores the data in the ROM 22 through the keyboard driver 24. At the same time, the CPU 14 transfers the address data to the mobile device 1 via the external interface drivers 12 and 26. The CPU 3 of the mobile device 1, which has received the data, collates each item of the data with data stored in the ROM 8. If the address data do not exist in the ROM 8, the data are stored in the ROM 8 as address data. Besides, if the same address data exist, the address data are discarded, and the operations are completed.

In the above description, the mobile device 1 and the portable visual terminal 13 are connected to each other. However, there can be a case where the mobile device 1 and the portable visual terminal 13 are not connected, and each of the address files is renewed individually. Consequently, it is preferable that the address files are mutually checked every time the mobile device 1 and the portable visual terminal 13 are connected. FIG. 4 is a flow chart showing processing operations in this case. When the respective CPUs 3 and 14 perceive that the mobile device 1 and the portable visual terminal 13 are connected by the interruption from the external interface drivers 12 and 26, the operation proceeds to the address data exchange phase (step S32).

First, variable value n, which indicates the ordinal number of data in the address file on the mobile device side (referred to as mobile device 1—address pointer hereinbelow), is set to the beginning value 1 (step S32). Address data Address 1 [n] indicated by address pointer [n] are transferred to the portable visual terminal 13 (step S33). The CPU 14 collates Address 1 [n] with a group of data stored in the ROM 22 (step S34), and judges whether or not the same data exist in the address file on the portable visual terminal 13 side (step S35). In the case where the same data do not exist (step S35: NO), the CPU 14 of the portable visual terminal 13 additionally stores Address 1 [n] in the ROM 22 as address data, and notifies the CPU 3 at the mobile device 1 of the event (step S36). In the case where the same data exist (step S35: YES), the CPU 14 disposes of Address 1 [n], and notifies the CPU 3 at the mobile device 1 of the event. The CPU 3, which acknowledges that the data collation has been completed on the terminal 13 side, collates the address pointer n of Address 1 with LastDataNumber 1, which is the number of the last data in the address file (step S37). At this step, if address pointer n is a smaller value than LastDataNumber 1, 1 is added to address pointer n (step S38), and the above steps S33 to S38 are reiterated for the address data Address 1 [n+1]. The operations are repeatedly performed until the last data in the address file of the mobile device 1 are transferred to the terminal 13, that is, until address pointer n becomes equal to LastDataNumber 1, and thereby the address file on the portable visual terminal 13 side is fully complemented.

After that, the same processing operations as above steps S39 to S45 are performed for the address file on the mobile device 1 side. The address data on the portable visual terminal 13 side are transferred to the mobile device 1 until the address file on the mobile device 1 side is fully complemented, and thereby the operations are completed (step S46). Thus a user can have the address data in common in two terminals: the mobile device 1 and the portable visual device 13.

As set forth hereinabove, a portable visual terminal according to the present invention has a marked practical effect as follows. First, the trouble of inputting data to address files is reduced. The reason is that in the structure of the present invention, only a mobile device has an address file that can be edited, and a portable visual terminal downloads data from the address file of the mobile device accordingly. Second, it is possible to minimize a portable visual terminal. The reason is that there is no need to provide an input means to the portable visual terminal.

While the preferred embodiments of the present invention have been described using specific terms, such description is for illustrative purposes only, and it is to be understood that changes and variations may be made without departing from the spirit or the scope of the following claims.

What is claimed is:

1. A discrete type portable visual terminal system comprising a connectable/separable mobile device and a portable visual terminal, each of which includes a controller, a memory for storing address data and an external interface driver, wherein:
address data stored in the memory of the mobile device or the portable visual terminal are transferred to the other memory via the external interface drivers to be shared between the mobile device and the portable visual terminal.

2. A discrete type portable visual terminal system as claimed in claim 1, wherein only the mobile device includes an address data input means such as a keyboard and a software keyboard, and address data of the mobile device are transferred to the portable visual terminal.

3. A discrete type portable visual terminal system as claimed in claim 1, wherein the address data of the mobile device are automatically transferred to the portable visual terminal when the mobile device and the portable visual terminal are connected.

4. A discrete type portable visual terminal system as claimed in claim 2, wherein the address data of the mobile device are automatically transferred to the portable visual terminal when the mobile device and the portable visual terminal are connected.

5. A discrete type portable visual terminal system as claimed in claim 1, wherein the address data of the mobile device are automatically transferred to the portable visual terminal when the address data of the mobile device are renewed.

6. A discrete type portable visual terminal system as claimed in claim 2, wherein the address data of the mobile device are automatically transferred to the portable visual terminal when the address data of the mobile device are renewed.

7. A discrete type portable visual terminal system as claimed in claim 1, wherein each of the mobile device and the portable visual terminal is provided with an address data input means, and address data are mutually transferred to complement each other's address file when the mobile device and the portable visual terminal are connected.
